(19) United States
(12) Patent Application Publication
(10) Pub. No.: US 2021/0366433 A1
(43) Pub. Date: Nov. 25, 2021

(54) INFORMATION PROCESSING APPARATUS AND CONTROL METHOD

(71) Applicant: Lenovo (Singapore) Pte. Ltd., Singapore (SG)

(72) Inventor: Hiroshi Itoh, Kanagawa (JP)

(73) Assignee: Lenovo (Singapore) Pte. Ltd., Singapore (SG)

(21) Appl. No.: 17/234,183

(22) Filed: Apr. 19, 2021

(30) Foreign Application Priority Data
May 19, 2020 (JP) 2020-87536

(51) Int. Cl. G09G 5/00; G06F 3/0481; G06F 3/14

(52) U.S. Cl. CPC G09G 5/006; G06F 3/0481; G09G 2320/08; G09G 2360/04; G09G 2356/00; G06F 3/1423

(57) ABSTRACT

An information processing apparatus is capable of controlling displaying on each of display areas and includes: a launch control part that launches applications set for the respective display areas with a common operation; and a display control part that displays each of the applications launched by the launch control part on corresponding one of the display areas.

### TECHNICAL FIELD

The present invention relates to an information processing apparatus and a control method.

### Background

A personal computer (PC) offers a function of an extended display provided by an operating system (OS). When, for example, the PC has another display in addition to its main display, not only the two displays can display the same image simultaneously but also the additional display can be used as an extended display so that a main screen of the main display and an extended screen of the extended display collectively constitute one screen (see, e.g., Japanese Unexamined Patent Application Publication No. 2000-112597).

When a new application is launched, it is first displayed on the main screen. A drag-and-drop operation with a mouse or the like can then move the display of the launched application from the main screen to the extended screen, although the screens seem to be discontinuous. This, however, means that the moving operation is inconveniently required to display and use the launched application on the extended screen.

In PCs having two-screen displays, different extended display functions may be provided depending on the OS. For example, Windows 10 (registered trademark) provides the above extended display function, and accordingly, a newly launched application is displayed on the main screen.

On the other hand, in Windows 10X (registered trademark), which is a planned next-generation OS, application launchers with the same specifications are respectively provided for the two screens. This allows different applications to be selected and launched for the respective screens. Launching thus different applications for the respective screens, however, requires two launching operations of the respective applications by using different application launchers for the respective screens.

### SUMMARY

One or more embodiments provide an information processing apparatus and a control method for appropriately controlling launching and displaying of an application(s) on a plurality of display areas with a simple operation.

According to one or more embodiments, an information processing apparatus capable of controlling displaying on each of display areas that do not overlap one another includes: a launch control part that launches applications set for the respective display areas with a common operation; and a display control part that displays each of the applications launched by the launch control part on corresponding one of the display areas with the common operation.

The information processing apparatus further includes a setting part that sets information regarding applications to be set for the respective display areas based on a user operation, wherein the launch control part may launch the applications set for the respective display areas based on the information regarding the applications set by the setting part.

In the above information processing apparatus, the display control part may display each of the applications launched by the launch control part based on a specification of corresponding one of the display areas.

In the above information processing apparatus, the setting part may set information regarding an orientation of the display areas based on a user operation, and the display control part may display each of the applications launched by the launch control part based on the information regarding the orientation of the display areas set by the setting part.

In the above information processing apparatus, the display control part may be capable of switching a display mode between a first display mode in which each of the applications launched by the launch control part is displayed on corresponding one of the display areas and a second display mode in which the display areas are used as the same display area and an application launched by the launch control part is displayed on each of the display areas, and the setting part may set the display mode to the first display mode or the second display mode based on a user operation.

In the above information processing apparatus, after an application launched by the launch control part is displayed in the first display mode or the second display mode set by the setting part, if the display mode is changed, the display control part may redisplay said application in accordance with the changed display mode.

The above information processing apparatus may include an acquisition part that acquires specification information regarding specifications of the display screens.

According to one or more embodiments, an information processing apparatus capable of controlling displaying on each of display areas that do not overlap one another includes: a setting part that sets applications for the respective display areas based on a user operation; a launch control part that launches an application set for at least one of the display areas by the setting part with a specific operation; and a display control part that displays the application launched by the launch control part on a corresponding display area set by the setting part with the specific operation.

According to one or more embodiments, a control method in an information processing apparatus capable of controlling displaying on each of display areas that do not overlap one another includes steps of: launching, by a launch control part, applications set for the respective display areas with a common operation; and displaying, by a display control part, each of the applications launched by the launch control part on corresponding one of the display areas with the common operation.

According to one or more embodiments, a control method in an information processing apparatus capable of controlling displaying on each of display areas that do not overlap one another includes steps of: setting, by a setting part, applications for the respective display areas based on a user operation; launching, by a launch control part, an application set for at least one of the display areas by the setting part with a specific operation; and displaying, by a display control part, the application launched by the launch control part on a corresponding display area set by the setting part with the specific operation.

According to one or more embodiments, it is possible to appropriately control launching and displaying an application(s) on display areas with a simple operation.

### BRIEF DESCRIPTION OF THE DRAWINGS

FIG. 1 is a system chart illustrating a configuration example of an information processing system according to a first embodiment.

FIG. 2 illustrates an example of a setting window for setting multiple screens according to the first embodiment.

FIG. 3 is a block diagram illustrating a configuration example of an information processing apparatus according to the first embodiment.

FIG. 4 is a block diagram illustrating an example of a function configuration of a control unit according to the first embodiment.

FIG. 5 is a flow chart illustrating an example of a control process for launching and displaying an application(s) according to the first embodiment.

FIG. 6 is a flow chart illustrating an example of a control process for displaying the launched application(s) according to the first embodiment.

FIG. 7 is an external perspective view illustrating an information processing apparatus according to a second embodiment.

FIG. 8 illustrates a configuration example of a display screen according to a third embodiment.

### DETAILED DESCRIPTION

Embodiments of the present invention will now be described in detail with reference to the drawings.

### First Embodiment

An overview is first provided of an information processing apparatus according to a first embodiment of the present invention.

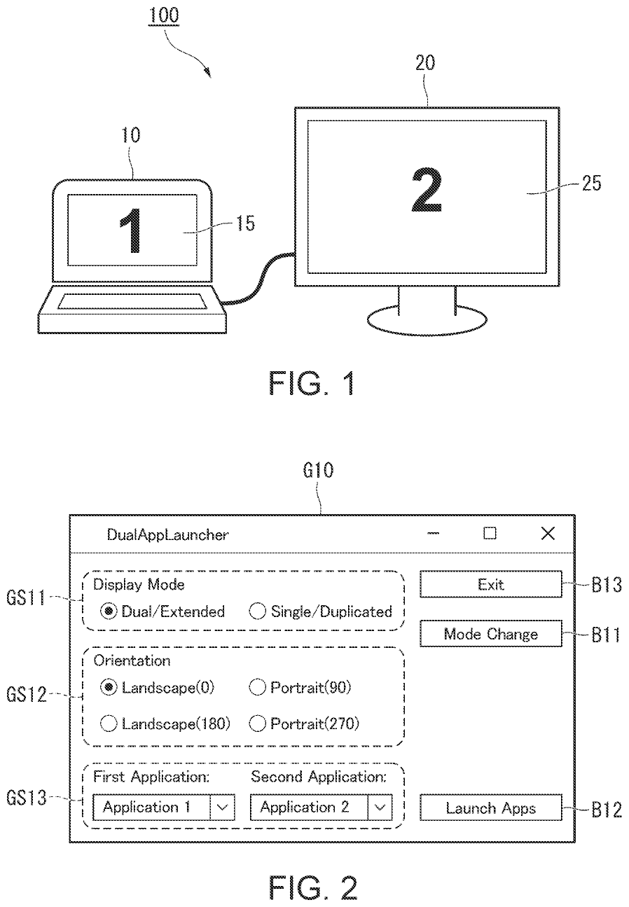

FIG. 1 is a system chart illustrating a configuration example of an information processing system 100 according to one or more embodiments. The information processing system 100 includes an information processing apparatus 10 and a display device 20. The illustrated information processing apparatus 10 is a clamshell-type (i.e., laptop) PC. The information processing apparatus 10, however, may alternatively be a desktop PC or a tablet PC. The display device 20 is an external display device that can be connected to the information processing apparatus 10. Connecting the display device 20 to the information processing apparatus 10 adds a display screen or a display area of a display unit 25 of the display device 20 to a display screen or a display area of a display unit 15 to establish a multi-display environment. The display screen of the display unit 15 of the information processing apparatus 10 is hereinafter referred to as a “display screen 1”, and the display screen of the display unit 25 of the display device 20 as “display screen 2”. The display screen 2 may be a duplicate of the display screen 1. The display screen 2 may also extend the display screen 1 to collectively constitute one display screen. The display screen 1 serves as a main screen of the information processing apparatus 10 and the display screen 2 serves as an extended screen that is added to the display screen 1. As illustrated, the display screen 1 and the display screen 2 are display areas that do not overlap one another.

In the following, a setting in which the display screen 2 is a duplicate of the display screen 1 is referred to as “duplicate display mode”. In the duplicate display mode, the display screen 1 and the display screen 2 are used as the same display screen: when the information processing apparatus 10 launches an application (application program) to be executed, the launched application is displayed on each (both) of the display screen 1 and the display screen 2.

A setting, on the other hand, in which the display screen 2 extends the display screen 1 is referred to as “extended display mode”. In the extended display mode, when the information processing apparatus 10 launches an application (application program) to be executed, a setting can be made whether the launched application is displayed on the display screen 1 or the display screen 2. For example, this setting can be performed by a launcher. The launcher is a program having a function of launching an application with a simple operation such as a click of a mouse and is executed on the OS.

FIG. 2 illustrates an example of a setting window for setting multiple screens according to one or more embodiments. The illustrated setting window G10 is distinct from a setting window for setting the display by the OS and appears in a dialog box, for example, as the launcher or a setting window of the launcher. The setting window G10 is displayed on the display screen 1 (i.e., main screen) of the information processing apparatus 10.

In the setting window G10, a symbol GS11 refers to an area (“Display Mode”) in which a display mode can be set. The extended display mode (“Dual/Extended”) and the duplicate display mode (“Single/Duplicated”) are displayed as options. A user can choose (by clicking, for example) one of radio buttons to select the extended display mode or the duplicate display mode.

A symbol GS12 refers to an area (“Orientation”) in which an orientation of the screens can be set. The screens can be oriented horizontally so that they are greater in width than in height (“Landscape”) or vertically so that they are greater in height than in width (“Portrait”). For example, four different screen orientations are displayed as options: “Landscape (0)” is a basic orientation of the screen in which a rotation angle is 0 degree; “Portrait (90)” is an orientation in which the screen is rotated by 90 degrees from the basic orientation; “Landscape (180)” is an orientation in which the screen is rotated by 180 degrees from the basic orientation; and “Portrait (270)” is an orientation in which the screen is rotated by 270 degrees. The user can choose (by clicking, for example) one of radio buttons to select either of the screen orientations.

A mode button B11 labeled “Mode Change” is provided as an operation piece for changing the display mode and the screen orientation to the selected ones. Upon a user operation (a click, for example) of the mode button B11, the display mode and the screen orientation are updated to the selected ones.

A symbol GS13 refers to an area in which applications can be respectively set for the display screen 1 and the display screen 2 in the extended display mode. An application to be displayed on the display screen 1 upon a launch thereof is set in “First Application”. An application to be displayed on the display screen 2 upon a launch thereof is set in “Second Application”. Applications installed on the information processing apparatus 10 are displayed in a pull-down menu for each of the “First Application” and the “Second Application” so that any of them can be selected therefrom. In the illustrated example, an application 1 (“Application 1”) is selected in the “First Application” as an application for the display screen 1. In the “Second Application”, on the other hand, an application 2 (“Application 2”) is selected as an application for the display screen 2.

A launch button B12 labeled “Launch Apps” is provided as an operation piece for launching the applications set in the “First Application” and the “Second Application”. Upon a user operation (a click, for example) of the launch button B12, the information processing apparatus 10 launches the application 1 and the application 2, displays the launched application 1 on the display screen 1, and displays the launched application 2 on the display screen 2. For example, in a case where the application 1 is a mailer (i.e., an email software) and the application 2 is a browser, the information processing apparatus 10 only requires a user operation (a click, for example) of the launch button B12 to launch the mailer and the browser, to display the mailer on the display screen 1, and to display the browser on the display screen 2.

Display sizes (window sizes) of the launched applications change depending on resolutions, etc., of the display screens. The information processing apparatus 10 thus displays the launched application 1 on the display screen 1 and the launched application 2 on the display screen 2 based on specifications of the respective display screens. For example, the information processing apparatus 10 displays the applications respectively in predetermined display sizes on the display screens in accordance with the resolutions thereof.

Specifically, the display screens may have different resolutions such as that the resolution of the display screen 1 is 1280×720 and the resolution of the display screen 2 is 1960×1080. The information processing apparatus 10 then displays the application 1 based on the display screen 1's resolution of 1280×720 so that the display size of the application 1 occupies a certain display area of the display screen 1 (which, for example, is equal to the display area of the display screen 1 or a maximum display size). The information processing apparatus 10 also displays the application 2 based on the display screen 2's resolution of 1960×1080 so that the display size of the application 2 occupies a certain display area of the display screen 2 (which, for example, is equal to the display area of the display screen 2 or a maximum display size). It is to be noted that the information processing apparatus 10 may respectively display the applications in areas smaller than (e.g., areas which occupy 90% of) the display areas of the display screens. The information processing apparatus 10 may also respectively display the applications on the display screens in sizes determined by the applications. Thus, irrespective of different resolutions of the display screens, the information processing apparatus 10 can respectively display the launched applications in appropriate sizes on the display screens based on the resolutions thereof. The information processing apparatus 10 may also respectively display the applications based on aspect ratios of the display screens instead of or in addition to the resolutions thereof. Thus, irrespective of different resolutions and/or aspect ratios of the display screens, the information processing apparatus 10 can respectively display the launched applications in appropriate sizes on the display screens based on the resolutions and/or the aspect ratios thereof.

The same application may be selected in the “First Application” and the “Second Application” if that application (such as a browser) is capable of being launched in a plurality of windows simultaneously. Take a case in which an application is selected from the pull-down menu for one of the “First Application” and the “Second Application”, for example. If it is not such an application that is capable of being launched in a plurality of windows simultaneously, the pull-down menu for the other may exclude it and present a list of other applications for selection.

It is also possible to select an application in only one of the “First Application” and the “Second Application”. Take a case in which the application 1 is selected in the “First Application” and no application is selected in the “Second Application”. Upon an operation (a click, for example) of the launch button B12, the information processing apparatus 10 launches the application 1 only and displays the launched application 1 on the display screen 1. Meanwhile, in a case where the application 2 is selected in the “Second Application” and no application is selected in the “First Application”, upon an operation (a click, for example) of the launch button B12, the information processing apparatus 10 launches the application 2 only and displays the launched application 2 on the display screen 2. In the latter case, the application can be launched and displayed on the display screen 2 upon an operation of the launcher (launch button B12) displayed on the display screen 1.

A function equivalent to the launch button B12 (i.e., a launcher that launches the application(s)) may be displayed on a task bar. Then, upon an operation (a click, for example) of the launcher on the task bar, the information processing apparatus 10 may launch and display the set application(s) on the corresponding display screen(s). A right click on the launcher on the task bar may present a menu from which “Setting” is selected to display the setting window G10 illustrated in FIG. 2.

A button B13 labeled “Exit” is provided as an operation piece for closing the setting window G10. When the user operates (clicks, for example) the button B13, the dialog display of the setting window G10 is completed.

### (Configuration of Information Processing Apparatus 10)

A specific configuration of the information processing apparatus 10 is now described.

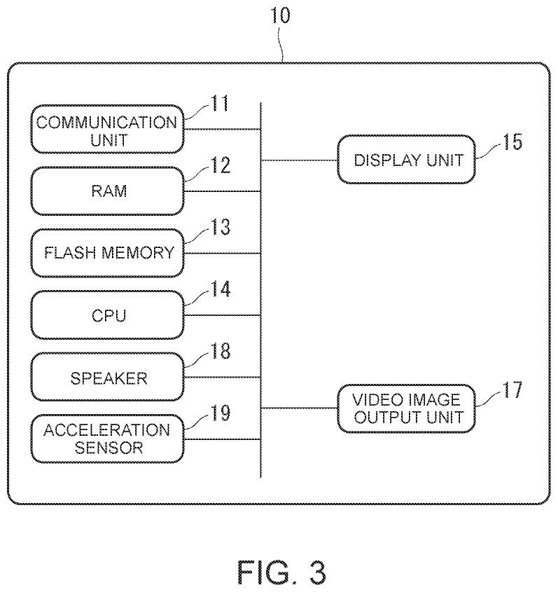

FIG. 3 is a block diagram illustrating a configuration example of the information processing apparatus 10 according to one or more embodiments. The information processing apparatus 10 includes a communication unit 11, a random access memory (RAM) 12, a flash memory 13, a central processing unit (CPU) 14, a display unit 15, a video image output unit 17, a speaker 18, and an acceleration sensor 19. These components are communicably connected via a bus or the like.

The communication unit 11 is configured to include, for example, digital input/output ports such as a plurality of Ethernet (registered trademark) ports or a plurality of universal serial bus (USB) ports, a communication device for wireless communication such as Bluetooth (registered trademark), Wi-Fi (registered trademark), etc., and so on.

In the RAM 12, a program and data to be, e.g., computed, controlled, and processed by the CPU 14 are developed and the various data is appropriately stored or deleted. The RAM 12 also functions as a video memory (V-RAM) for the display unit 15.

The flash memory 13 is a non-volatile memory such as a flash read only memory (ROM). The flash memory 13 stores, for example, a program and setting data of a basic input output system (BIOS), a program of the OS, a program of an application operating on the OS, etc.

The CPU 14 executes the program of the BIOS, OS, or various applications operating on the OS to perform various calculations and processes. For example, the CPU 14 executes the above program to perform memory control for reading/writing data in and erasing data from the RAM 12, flash memory 13 and others, display control for the display unit 15, output control for the video image output unit 17, sound control for output sound of the speaker 18, etc. The CPU 14 may also be configured to include a unit for performing a specific calculation and process such as a graphics processing unit (GPU) inside or outside thereof.

The display unit 15 is configured to include a liquid crystal display, an organic EL display, or the like and displays an image in accordance with the process performed by the BIOS, OS, or various applications operating on the OS executed by the CPU 14. The display unit 15 may be a display of a touch panel type.

The video image output unit 17 is configured to include an external monitor output terminal for a connection to an external display device. The external monitor output terminal is, for example, an HDMI (registered trademark) terminal, a DVI terminal, a D-SUB terminal, a display port terminal, or the like. The speaker 18 outputs electronic sounds, voices, and so on. The acceleration sensor 19 detects an orientation and a change of orientation of the information processing apparatus 10.

Now, among the functions executed by the CPU 14, description is made of a configuration of the function of controlling launching and displaying of the application(s) in accordance with the display mode. The CPU 14 includes a control unit 140 as a function configuration realized by executing the program.

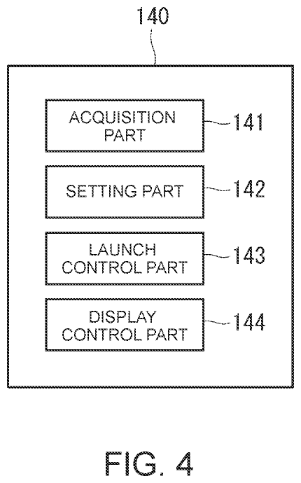

FIG. 4 is a block diagram illustrating an example of a function configuration of the control unit 140 according to one or more embodiments. The control unit 140 includes an acquisition part 141, a setting part 142, a launch control part 143, and a display control part 144.

The acquisition part 141 acquires specification information regarding specifications of the respective display screens. The specification information is information about the display screens such as the resolutions, aspect ratios, etc. thereof. For example, the acquisition part 141 uses an API of the OS to acquire the specification information of the display screen 1 (the display unit 15 of the information processing apparatus 10) and the specification information of the display screen 2 (the display unit 25 of the display device 20).

The setting part 142 sets the display mode to the extended display mode or the duplicate display mode in accordance with the selection based on the user operation in the setting window G10 illustrated in FIG. 2. The setting part 142 also sets the information regarding the orientation of the display screens in accordance with the orientation of the screens selected based on the user operation in the setting window G10 illustrated in FIG. 2. The setting part 142 further sets the information regarding the applications to be set for the respective display screens based on the user operation in the setting window G10 illustrated in FIG. 2. For example, the setting part 142 sets the application 1 selected in the pull-down menu of the “First Application” in the setting window G10 as the application for the display screen 1. The setting part 142 also sets the application 2 selected in the pull-down menu of the “Second Application” in the setting window G10 as the application for the display screen 2.

The launch control part 143 launches the applications set for the respective display screens with a common operation. For example, the launch control part 143 launches the applications set for the respective display screens based on the information regarding the applications set by the setting part 142. Specifically, in the example illustrated in FIG. 2, the launch control part 143 launches the application 1 set for the display screen 1 and the application 2 set for the display screen 2 in response to an operation of the launch button B12.

The display control part 144 can switch between the extended display mode and the duplicate display mode. Based on the display mode set by the setting part 142, the display control part 144 controls the display mode to either the extended display mode or the duplicate display mode. In the duplicate display mode, the display control part 144 uses the display screen 1 and the display screen 2 as the same display area and displays the application launched by the launch control part 143 on each (both) of the display screen 1 and the display screen 2.

In the extended display mode, on the other hand, the display control part 144 displays the applications launched by the launch control part 143 respectively on the display screens. For example, the display control part 144 displays the application 1, which has been set as the application for the display screen 1 by the setting part 142, on the display screen 1. The display control part 144 also displays the application 2, which has been set as the application for the display screen 2 by the setting part 142, on the display screen 2.

The display control part 144 displays the application 1 on the display screen 1 also based on the specification information (resolution, aspect ratio, etc.) of the display screen 1 acquired by the acquisition part 141. Likewise, the display control part 144 displays the application 2 on the display screen 2 based on the specification information (resolution, aspect ratio, etc.) of the display screen 2 acquired by the acquisition part 141.

After the application launched by the launch control part 143 is displayed in the extended display mode or the duplicate display mode as set by the setting part 142, if the display mode is changed, the display control part 144 redisplays the application in accordance with the changed display mode. For example, after the launched application is displayed in the extended display mode as set by the setting part 142, if the user uses a function of the OS to change the display mode to the duplicate display mode, the display control part 144 redisplays the application having been displayed in the duplicate display mode. If, after the launched application is displayed in the duplicate display mode as set by the setting part 142, the user uses the function of the OS to change the display mode to the extended display mode, the display control part 144 redisplays the application having been displayed in the extended display mode.

In any of the extended display mode and the duplicate display mode, the display control part 144 displays the applications launched by the launch control part 143 based on the information regarding the orientation of the display screens set by the setting part 142.

### (Operation of Control Process of Launching and Displaying)

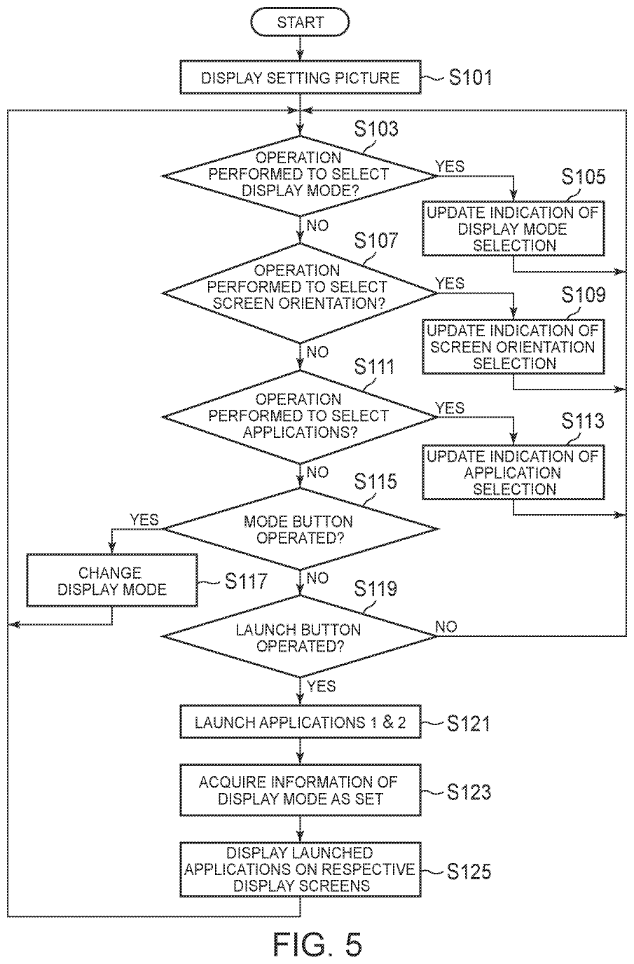

A description is now made of an operation of control process performed by the control unit 140 to control the launching and displaying of the application(s) in accordance with the display mode. FIG. 5 is a flow chart illustrating an example of the control process of the launch and display of the application(s) according to one or more embodiments. The process illustrated in FIG. 5 is an example of a control process of the launching and displaying in response to the user operation of the launcher (setting window G10 in FIG. 2).

In step S101, the control unit 140 displays the setting window G10 (see FIG. 2) on the display screen 1 upon a launch of the OS. The control unit 140 may alternatively display the setting window G10 on the display screen 1 in response to a user operation.

In step S103, the control unit 140 determines whether or not an operation has been performed to select the display mode in the setting window G10 (“Display Mode”). If control unit 140 determines that the selection operation of the display mode has been performed (“YES”), the process proceeds to step S105. If the control unit 140 determines that the selection operation of the display mode has not been performed (“NO”), the process proceeds to step S107.

In step S105, in accordance with the selection operation of the display mode, the control unit 140 updates an indication of the selection (in the example in FIG. 2, a radio button) indicating which one of the display modes has been selected. The process then returns to step S103.

In step S107, the control unit 140 determines whether or not an operation has been performed to select the orientation of the screens in the setting window G10 (“Orientation”). If the control unit 140 determines that the selection operation of the screen orientation has been performed (“YES”), the process proceeds to step S109. If the control unit 140 determines that the selection operation of the screen orientation has not been performed (“NO”), the process proceeds to step S111.

In step S109, in accordance with the selection operation of the screen orientation, the control unit 140 updates the selection indication (in the example in FIG. 2, a radio button) indicating which one of the screen orientations has been selected. The process then returns to step S103.

In step S111, the control unit 140 determines whether or not an operation has been performed to select the applications in the setting window G10. If the control unit 140 determines that the selection operation of the applications has been performed (“YES”) , the process proceeds to step S113. If the control unit 140 determines that the selection operation of the applications has not been performed (“NO”), the process proceeds to step S115.

In step S113, in accordance with the selection operation of the applications, the control unit 140 updates the selection indications (in the example in FIG. 2, “Application 1” for the “First Application” and “Application 2” for the “Second Application”) indicating which applications have been selected in the “First Application” and the “Second Application”. The process then returns to step S103.

In step S115, the control unit 140 determines whether or not an operation of the mode button B11 has been performed in the setting window G10. If the control unit 140 determines that the operation of the mode button B11 has been performed (“YES”), the process proceeds to step S117. If the control unit 140 determines that the operation of the mode button B11 has not been performed (“NO”), the process proceeds to step S119.

In step S117, the control unit 140 changes the display mode and the screen orientation to the ones as currently set in the setting window G10.

In step S119, the control unit 140 determines whether or not an operation of the launch button B12 has been performed in the setting window G10. If the control unit 140 determines that the operation of the launch button B12 has been performed (“YES”), the process proceeds to step S121. If the control unit 140 determines that an operation of the launch button B12 has not been performed (“NO”), the process returns to step S103.

In step S121, the control unit 140 launches the applications as currently set for the “First Application” and the “Second Application” in the setting window G10. In the example illustrated in FIG. 2, the control unit 140 launches the application 1 and the application 2. The process then proceeds to step S123.

In step S123, the control unit 140 acquires information of the display mode as currently set in the setting window G10. The process then proceeds to step S125.

In step S125, the control unit 140 displays the applications launched in step S121 on the display screen 1 and the display screen 2 in accordance with the display mode as currently set. In the extended display mode, the control unit 140 displays the application 1 set for the “First Application” on the display screen 1 and the application 2 set for the “Second Application” on the display screen 2. For example, the control unit 140 displays the application 1 on the display screen 1 based on the display screen 1's specification information (such as a resolution and an aspect ratio) and screen orientation so that the display size (window size) of the application 1 occupies a certain display area of the display screen 1 (for example, the certain display area is equal to the display area of the display screen 1 or has a maximum size). Likewise, the control unit 140 displays the application 2 on the display screen 2 based on the display screen 2's specification information (such as a resolution and aspect ratio) and screen orientation so that the display size (window size) of the application 2 occupies a certain display area of the display screen 2 (for example, the certain display area is equal to the display area of the display screen 2 or has a maximum size). In the duplicate display mode, on the other hand, the control unit 140 uses the display screen 1 and the display screen 2 as the same display area and displays the launched application on each (both) of the display screen 1 and the display screen 2.

Now, a description is made of a control process of displaying the applications after the applications have been launched by the launcher and displayed as illustrated in FIG. 5.

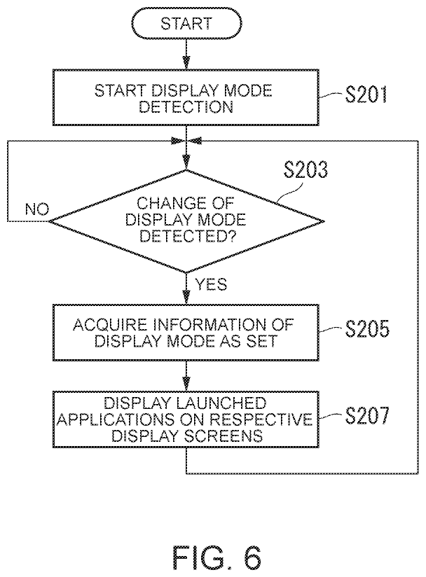

FIG. 6 is a flow chart illustrating an example of a control process for displaying the launched application(s) according to one or more embodiments.

After the application(s) is launched by the launcher, the user may change the display mode using the function of the OS. Thus, in step S201, upon the launch of the application(s) by the launcher, the control unit 140 starts detecting the display mode at a predetermined sampling period (for example, every two seconds). The process then proceeds to step S203.

In step S203, the control unit 140 determines whether or not the display mode has been changed based on the display mode detected at the predetermined period. If the control unit 140 has not detected a change of the display mode (“NO”), the detection continues at the predetermined period. If the control unit 140 has detected a change of the display mode (“YES”), the process proceeds to step S205.

In step S205, the control unit 140 acquires information of the display mode after the change. The process then proceeds to step S207.

In step S207, the control unit 140 redisplays the application(s) having been displayed on the display screen 1 or the display screen 2 in accordance with the changed display mode. For example, when the change is made from the duplicate display mode the extended display mode, the control unit 140 displays the application 1 on the display screen 1 and the application 2 on the display screen 2. For example, the control unit 140 displays the application 1 on the display screen 1 based on the display screen 1's specification information (such as a resolution and an aspect ratio) and screen orientation so that the display size (window size) of the application 1 occupies a certain display area of the display screen 1 (for example, the certain display area is equal to the display area of the display screen 1 or has a maximum size). Likewise, the control unit 140 displays the application 2 on the display screen 2 based on the display screen 2's specification information (such as a resolution and aspect ratio) and screen orientation so that the display size (window size) of the application 2 occupies a certain display area of the display screen 2 (for example, the certain display area is equal to the display area of the display screen 2 or has a maximum size). When, on the other hand, the change is made from the extended display mode to the duplicate display mode, the control unit 140 uses the display screen 1 and the display screen 2 as the same display area and redisplays the application having been displayed on each (both) of the display screen 1 and the display screen 2.

As described above, the information processing apparatus 10 according to one or more embodiments can control displaying on each of display areas that do not overlap one another. For example, the information processing apparatus 10 launches the respective applications set for the display screen 1 and the display screen 2 (which are an example of the display areas) with a common operation (an operation of the launch button B12 in FIG. 2, for example). The information processing apparatus 10 also displays the launched applications on the respective display screens with the common operation.

Thus, the information processing apparatus 10 can appropriately control launching and displaying of the applications on the display screens with a simple operation. In the conventional art, for example, a newly launched application was displayed on the display screen 1 (main screen) even when the application should be used on the display screen 2 (extended screen). Accordingly, a drag-and-drop operation with a mouse or the like was required to move the display of the launched application from the main screen to the extended screen, which was inconvenient. In the present invention, on the other hand, the application to be displayed on the display screen 1 and the application to be displayed on the display screen 2 are set in advance. This conveniently allows the newly launched application to be displayed on the desired display screen with a simple operation.

For example, the information processing apparatus 10 sets the information regarding the respective applications to be set for the display screen 1 and the display screen 2 based on a user operation. The information processing apparatus 10 then launches the applications respectively set for the display screen 1 and the display screen 2 (for example, the application 1 and the application 2) based on the set information regarding the applications.

Setting thus the applications for the respective display screens in advance allows the information processing apparatus 10 to appropriately control launching and displaying of the applications on the display screens with a simple operation.

The information processing apparatus 10 also displays the launched applications respectively based on the specifications (for example, resolutions and/or aspect ratios) of the display screens.

Thus, the information processing apparatus 10 can display the applications on the respective display screens in appropriate display sizes based on the specifications of the respective display screens (for example, resolutions and/or aspect ratios). This allows the applications to be displayed in appropriate sizes in accordance with the respective resolutions even when, for example, the resolution of the display screen 1 of the information processing apparatus 10 and the resolution of the display screen 2 of the display device 20 are different.

The information processing apparatus 10 sets information regarding the orientation of the display screen 1 and the display screen 2 based on a user operation. The information processing apparatus 10 then displays the launched applications respectively based on the set information regarding the orientation of the display screen 1 and the display screen 2.

Thus, the information processing apparatus 10 can display the applications on the respective display screens in appropriate display sizes in accordance with the orientation of the display screens.

The information processing apparatus 10 can also switch the display mode between the extended display mode (which is an example of the first display mode) in which the launched applications are respectively displayed on the display screens and the duplicate display mode (which is an example of the second display mode) in which the display screen 1 and the display screen 2 are used as the same display screen and the launched application is displayed on each of the display screen 1 and the display screen 2. The information processing apparatus 10 sets the display mode to the extended display mode or the duplicate display mode based on a user operation.

Thus, the information processing apparatus 10 can switch between the extended display mode and the duplicate display mode in accordance with a user operation and can appropriately control launching and displaying of the applications on the display screens in each of the display modes with a simple operation.

After the launched application is displayed in the set extended display mode or duplicate display mode, if the display mode is changed, the information processing apparatus 10 redisplays said application in accordance with the changed display mode.

Thus, after the application is launched and displayed in the extended display mode or the duplicate display mode, if the display mode is changed, the information processing apparatus 10 can appropriately change the display of the application in accordance with the changed display mode.

The information processing apparatus 10 acquires the specification information regarding the specifications of the display screens.

This allows the information processing apparatus 10 to display the applications in appropriate display sizes in accordance with the specifications of the respective display screens. For example, when a display device 20 is connected to the information processing apparatus 10, the information processing apparatus 10 acquires the specification information of the display screen 2 from the connected display device 20, which allows the application to be displayed in an appropriate display size.

The information processing apparatus 10 according to one or more embodiments sets the applications for the respective display screens that do not overlap one another based on a user operation (for example, an operation for setting the applications in the area indicated by the symbol GS13 in FIG. 2). The information processing apparatus 10 then launches the application(s) set for at least one of the display screens with a specific operation (for example, an operation of the launch button B12 in FIG. 2) and displays the launched application(s) on the display screen(s) with the specific operation.

Thus, the information processing apparatus 10 can launch and display the application(s) set by the user on that one(s) of the display screens which was set by the user. For example, upon a user operation of the launcher (setting window G10) displayed on the display screen 1, the information processing apparatus 10 can launch and display the application set in advance by the user on any of the display screen 1 and the display screen 2. Thus, the information processing apparatus 10 can appropriately control launching and displaying of the applications on the display screens with a simple operation.

### Second Embodiment

A second embodiment of the present invention is now described.

In the first embodiment, an example was described in which a launcher was used to control launching and displaying of the application on the display screen 1 of the display unit 15 of the information processing apparatus 10 and the display screen 2 of the display unit 25 of the display device 20. The same control can be performed in an information processing apparatus including two display screens.

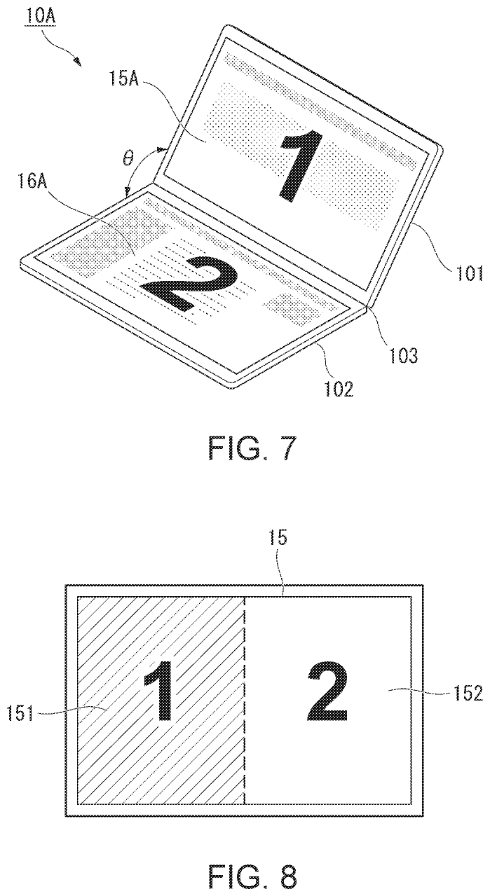

FIG. 7 is an external perspective view illustrating an information processing apparatus 10A according to one or more embodiments. The illustrated information processing apparatus 10A is similar to the information processing apparatus 10 illustrated in FIG. 1 in that it is a clamshell-type (i.e., laptop) PC, but differs in that it has a plurality of display parts. The information processing apparatus 10A includes a first chassis 101, a second chassis 102, and a hinge mechanism 103. The first chassis 101 and the second chassis 102 are substantially rectangular plate-like (for example, flat-plate-shaped) chassis. One of side surfaces of the first chassis 101 and one of side surfaces of the second chassis 102 are connected (coupled) via the hinge mechanism 103, and the first chassis 101 and the second chassis 102 are relatively rotatable about the hinge mechanism 103 serving as a rotation axis. When an opening angle 0 between the first chassis 101 and the second chassis 102 about the rotation axis is substantially 0°, the first chassis 101 and the second chassis 102 overlap each other and are thus closed (this is hereinafter referred to as a “closed condition”). Surfaces of the first chassis 101 and the second chassis 102 opposing each other in the closed condition are called “inner surfaces”, and opposite surfaces thereto are called “outer surfaces”. The opening angle 0 can also be defined as an angle formed by the inner surface of the first chassis 101 and the inner surface of the second chassis 102. In contrast to the closed condition, when the first chassis 101 and the second chassis 102 are opened, they are in an “opened condition”. In the opened condition, the first chassis 101 and the second chassis 102 have been relatively rotated so that the opening angle 0 is greater than a predetermined threshold value (10° , for example).

A first display unit 15A is provided on the inner surface of the first chassis 101. A second display unit 16A is provided on the inner surface of the second chassis 102. The first display unit 15A and the second display unit 16A are touch-panel-type displays, for example. The information processing apparatus 10A may be used in various usage forms: it may be used not only in a clamshell mode as a PC of the clamshell type (i.e., laptop) as illustrated but also in a tablet mode in which the first chassis 101 and the second chassis 102 are in the opened condition opened to form an opening angle θ of approximately 180° .

In one or more embodiments, the display screen of the first display unit 15A serves as the display screen 1 and the display screen of the second display unit 16A serves as the display screen 2. This allows the information processing apparatus 10A to control launching and displaying of the applications using the launcher as in the first embodiment. As illustrated, the display screen 1 and the display screen 2 are display areas that do not overlap one another. It is to be noted that, in one or more embodiments, the information processing apparatus 10A may decide whether or not to perform the control using the launcher based on the opening angle θ. For example, the information processing apparatus 10A may not perform the control using the launcher in the clamshell mode and may perform it in the tablet mode. The information processing apparatus 10A may, for example, be provided with acceleration sensors 19 in the first chassis 101 and the second chassis 102 respectively so that the opening angle θ is detected based on the outputs of the acceleration sensors 19.

### Third Embodiment

A third embodiment of the present invention is now described.

In the first and second embodiments, two independent display screens have been respectively referred to as the display screen 1 and the display screen 2. However, a display screen may be divided into two display areas and they may be respectively referred to as a display screen 1 and a display screen 2.

FIG. 8 illustrates a configuration example of a display screen according to one or more embodiments. It shows the display unit 15 of the information processing apparatus 10 illustrated in FIG. 1. The information processing apparatus 10 divides the display screen of the display unit 15 into two areas on right and left bounded by a center thereof and controls a first display area 151 on the left and a second display area 152 on the right each as an independent display area (i.e., independent display screen). It is not possible to display one of the first display area 151 and the second display area 152 to overlap at least a part of the other. That is, they are display areas that do not overlap one another. In one or more embodiments, for example, the first display area 151 serves as the display screen 1 and the second display area 152 serves as the display screen 2. This allows the information processing apparatus 10 to control launching and displaying of the applications using the launcher as in the first embodiment.

One or more embodiments of the present invention have been described in the above with reference to the drawings. Note that the specific configuration thereof is not limited to those described above, and various design changes and the like may be made within the scope of the present invention. For example, the configurations described in the above embodiments may be combined arbitrarily.

While examples have been described in the above embodiments in which a launcher is used to control launching and displaying of the applications on two display screens (display areas), i.e., the display screen 1 and the display screen 2, the control of launching and displaying of the applications may be performed on three or more display screens (display areas).

An operation in the setting window G10 may be performed in any way, such as by a click operation by a mouse, a touch operation on the display screen, an operation by a gesture, etc.

The above-described control unit 140 includes a computer system therein. A process in each component included in the control unit 140 may be executed by recording a program for realizing functions of the respective components included in the control unit 140 in a computer readable recording medium and causing the computer system to read the program recorded in the recording medium for execution. Here, “causing the computer system to read the program recorded in the recording medium for execution” includes installing the program in the computer system. The “computer system” herein may include an OS and hardware such as a peripheral device. The “computer system” may include a plurality of computer devices connected via a network including the Internet, a WAN, a LAN, and a communication line such as a dedicated line. The “computer readable recording medium” may refer to a portable medium such as a flexible disk, a magneto-optical disk, a ROM or a CD-ROM, or a storage device such as a hard disk incorporated in the computer system. Thus, a recording medium storing the program may be a non-transitory recording medium such as a CD-ROM.

The recording medium may include an internally- or externally-provided recording medium that is accessible from the distribution server to distribute the program. The program may be divided into a plurality of program parts to be downloaded at different timings and then combined in each component included in the control unit 140. The divided program parts may be respectively distributed by different distribution servers. The “computer-readable recording medium” may include a medium that holds the program for a certain period of time such as a volatile memory (RAM) inside the computer system serving as a server or a client when the program is transmitted via the network. The program may be one for realizing a part of the functions described above. The program may also be one that can realize the functions described above in combination with a program already recorded in the computer system, or a so-called differential file (differential program).

Moreover, a part or all of the functions of the control unit 140 in the above-described embodiments may be realized as an integrated circuit such as a large scale integration (LSI). Each function may be formed into a processor individually, or a part or all of the functions may be integrated and formed into a processor. The circuit integration may be realized not only with the LSI but also with a dedicated circuit or a general purpose processor. If, due to advance in circuit integration technology, an alternative to the LSI is found, an integrated circuit according to the technology may be used.

In the above embodiments, examples have been described in which the information processing apparatus 10 is a clamshell type PC. The information processing apparatus 10, however, may alternatively be a tablet PC or a desktop PC. Moreover, it is not limited to a PC but may be a smartphone, a game device, etc.
10, 10A Information processing apparatus
11 Communication unit
12 RAM
13 Flash memory
14 CPU
15 Display unit
15A First display unit
16A Second display unit
17 Video image output unit
18 Speaker
19 Acceleration sensor
100 Information processing system
101 First chassis
102 Second chassis
103 Hinge mechanism
140 Control unit
141 Acquisition part
142 Setting part
143 Launch control part
144 Display control part

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing apparatus capable of controlling displaying on each of display areas that do not overlap one another, comprising:
a launch control part that launches applications set for the respective display areas with a common operation; and
a display control part that displays each of the applications on corresponding one of the display areas with the common operation.

2. The information processing apparatus according to claim 1, further comprising:
a setting part that sets information regarding applications to be set for the respective display areas based on a user operation,
wherein the launch control part launches the applications set for the respective display areas based on the information regarding the applications set by the setting part.

3. The information processing apparatus according to claim 1, wherein the display control part displays each of the applications launched by the launch control part based on a specification of corresponding one of the display areas.

4. The information processing apparatus according to claim 2, wherein
the setting part sets information regarding an orientation of the display areas based on a user operation, and
the display control part displays each of the applications launched by the launch control part based on the
information regarding the orientation of the display areas set by the setting part.

5. The information processing apparatus according to claim 2, wherein
the display control part is capable of switching a display mode between a first display mode and a second display mode,
in the first display mode, each of the applications launched by the launch control part is displayed on corresponding one of the display areas,
in the second display mode, the display areas are used as the same display area and an application launched by the launch control part is displayed on each of the display areas, and
the setting part sets the display mode to the first display mode or the second display mode based on a user operation.

6. The information processing apparatus according to claim 5, wherein, after an application launched by the launch control part is displayed in the first display mode or the second display mode set by the setting part, if the display mode is changed, the display control part redisplays the application in accordance with the changed display mode.

7. The information processing apparatus according to claim 1, further comprising:
an acquisition part that acquires specification information regarding specifications of display screens.

8. An information processing apparatus capable of controlling displaying on each of display areas that do not overlap one another, comprising:
a setting part that sets applications for the respective display areas based on a user operation;
a launch control part that launches an application set for at least one of the display areas by the setting part with a specific operation; and
a display control part that displays the application launched by the launch control part on a corresponding display area set by the setting part with the specific operation.

9. A control method in an information processing apparatus capable of controlling displaying on each of display areas that do not overlap one another, comprising steps of:
launching, by a launch control part, applications set for the respective display areas with a common operation; and
displaying, by a display control part, each of the applications launched by the launch control part on corresponding one of the display areas with the common operation.
